(19) United States
(12) Patent Application Publication
(10) Pub. No.: US 2025/0127202 A1
(43) Pub. Date: Apr. 24, 2025

(54) INFANT FOOD PRODUCT

(71) Applicant: Cargill, Incorporated, Wayzata, MN (US)

(72) Inventor: Falk BRÜSE, Drensteinfurt (DE)

(73) Assignee: Cargill, Incorporated, Wayzata, MN (US)

(21) Appl. No.: 16/647,303

(22) PCT Filed: Sep. 18, 2018
(86) PCT No.: PCT/US2018/051455

§ 371 Date: Mar. 13, 2020

(30) Foreign Application Priority Data
Sep. 19, 2017 (EP) 17191867.5
Mar. 5, 2018 (EP) 18159940.8

(51) Int. Cl. A23L 33/115; A23D 9/00; A23L 33/00

(52) U.S. Cl. CPC A23L 33/115; A23D 9/00; A23L 33/40

(57) ABSTRACT

The present invention relates to a fat composition comprising at least one palm oil and/or palm oil based material and the palm oil and/or palm oil based material is having a content of di-acylglycerides less than 3% and a content of unwanted propanol components of less than 0.8 ppm, and its use in an infant food product.

### CROSS-REFERENCE TO RELATED APPLICATIONS

This application claims the benefit of European Patent Application Serial No. 17191867.5 filed 19 Sep. 2017, entitled “INFANT FOOD PRODUCT”, and European Patent Application Serial No. 18159940.8 filed 5 Mar. 2018, entitled “INFANT FOOD PRODUCT”, which applications are hereby incorporated by reference herein in their entirety.

### FIELD OF THE INVENTION

Use of fat composition comprising palm oil and/or palm oil based material having a content of di-acylglycerides less than 3% and a content of unwanted propanol components of less than 0.8 ppm in infant food product.

### BACKGROUND OF THE INVENTION

Infants need good quality nourishment in sufficient quantities in order to thrive.

Diet, among other environmental and genetic factors, is recognized to have an important role in health and disease prevention. Various functional food ingredients could affect beneficial modifications in the composition and the activities of gut microflora of infants, with opportunities for nutritional modulation.

Important challenges that the infant formula manufacturers face are the ability to mimic as close as possible the nutritional properties of human milk and to reach high quality standards set for infant nutrition in terms of absence of contaminants at a microbiological and/or chemical level. Infant formulae are available in the market in the following forms: powder, infant base powder, liquid concentrate, and ready-to-feed.

There is still a need for a suitable fat composition that can be used in infant food products. The current invention provides such a composition.

### SUMMARY OF THE INVENTION

The current invention relates to a fat composition comprising at least one palm oil and/or palm oil based material, and at least one lipid-based material selected from the group consisting of
a) a lauric fat,
b) medium chain triglycerides,
c) fat source containing long chain poly-unsaturated fatty acids,
d) milk fat,
e) liquid oil selected from the group consisting of oils from cotton, corn, groundnut, linseed, olive, rape, canola, rice bran, sesame, safflower, soybean, sunflower, high-oleic safflower, high-oleic sunflower, and mixture of two or more thereof,
f) a triglyceride composition comprising from 40 to 50% by weight of saturated fatty acid residues having 16 carbon atoms and from 40 to 50% by weight of unsaturated fatty acid residues having 18 carbon atoms and one double bond, and wherein from 50 to 60% by weight of the saturated fatty acid residues having 16 carbon atoms are present at the 2-position in a triglyceride, and
g) mixtures of two or more thereof,
and wherein and the palm oil and/or palm oil based material is having a content of di-acylglycerides less than 3% and a content of unwanted propanol components of less than 0.8 ppm.

Further it relates to an infant food product comprising infant food ingredients and at one palm oil and/or palm oil based material, and at least one lipid-based material selected from the group consisting of:
a) lauric fat,
b) medium chain triglycerides,
c) fat source containing long chain poly-unsaturated fatty acids,
d) milk fat,
e) liquid oil selected from the group consisting of oils from cotton, corn, groundnut, linseed, olive, rape, canola, rice bran, sesame, safflower, soybean, sunflower, high-oleic safflower, high-oleic sunflower, and combinations of two or more thereof,
f) a triglyceride composition comprising from 40 to 50% by weight of saturated fatty acid residues having 16 carbon atoms and from 40 to 50% by weight of unsaturated fatty acid residues having 18 carbon atoms and one double bond, and wherein from 50 to 60% by weight of the saturated fatty acid residues having 16 carbon atoms are present at the 2-position in a triglyceride, and
g) mixtures of two or more thereof,
and wherein and the palm oil and/or palm oil based material is having a content of di-acylglycerides less than 3% and a content of unwanted propanol components of less than 0.8 ppm.

Finally, it relates to the use of one palm oil and/or palm oil based material having a content of di-acylglycerides less than 3% and a content of unwanted propanol components of less than 0.8 ppm, with at least one lipid-based material selected from the group consisting of
a) lauric fat,
b) medium chain triglycerides,
c) fat source containing long chain poly-unsaturated fatty acid,
d) milk fat,
e) liquid oil selected from the group consisting of oils from cotton, corn, groundnut, linseed, olive, rape, canola, rice bran, sesame, safflower, soybean, sunflower, high-oleic safflower, high-oleic sunflower, and combinations of two or more thereof,
f) a triglyceride composition comprising from 40 to 50% by weight of saturated fatty acid residues having 16 carbon atoms and from 40 to 50% by weight of unsaturated fatty acid residues having 18 carbon atoms and one double bond, and wherein from 50 to 60% by weight of the saturated fatty acid residues having 16 carbon atoms are present at the 2-position in a triglyceride, and
g) mixtures of two or more thereof,
   to prepare an infant food product.

### DETAILED DESCRIPTION

The current invention relates to a fat composition comprising at least one palm oil and/or palm oil based material, and at least one lipid-based material selected from the group consisting of
a) a lauric fat,
b) medium chain triglycerides,
c) fat source containing long chain poly-unsaturated fatty acids,
d) milk fat,
e) liquid oil selected from the group consisting of oils from cotton, corn, groundnut, linseed, olive, rape, canola, rice bran, sesame, safflower, soybean, sunflower, high-oleic safflower, high-oleic sunflower, and mixture of two or more thereof,
f) a triglyceride composition comprising from 40 to 50% by weight of saturated fatty acid residues having 16 carbon atoms and from 40 to 50% by weight of unsaturated fatty acid residues having 18 carbon atoms and one double bond, and wherein from 50 to 60% by weight of the saturated fatty acid residues having 16 carbon atoms are present at the 2-position in a triglyceride, and
g) mixtures of two or more thereof,
and wherein the palm oil and/or palm oil based material is having a content of di-acylglycerides less than 3% and a content of unwanted propanol components of less than 0.8 ppm.

The “at least one palm oil and/or palm oil based material having a content of di-acylglycerides less than 3% and a content of unwanted propanol components of less than 0.8 ppm” is a palm oil that is obtainable by short path evaporation. Therefore it easily can be called a short-path evaporated (SPE) palm oil and/or short-path evaporated palm oil based material.

The term “short-path evaporated (SPE) palm oil and/or short-path evaporated palm oil based material” refers to SPE palm oil, while the SPE palm oil based material refers to palm oil which has been fractionated, hydrogenated, chemically interesterified, enzymatic interesterified or a combination of one or more of these treatments and subsequently the palm oil based material is short path evaporated. Preferably the SPE palm based material is fractionated palm oil and fractions such as stearin and olein fractions (single as well as double fractionated), palm mid fractions and blends of palm oil and/or its fractions are included as well and each of them have been treated by SPE.

In one aspect of the invention the “at least one palm oil and/or palm oil based material” is having a content of di-acylglycerides less than 3%, less than 2.5%, less than 2%, less than 1.5%. The “at least one palm oil and/or palm oil based material” is having a content of unwanted propanol components of less than 0.8 ppm, less than 0.7 ppm, less than 0.6 ppm, less than 0.5 ppm. The “at least one palm oil and/or palm oil based material” is obtainable by short path evaporation.

### Short Path Evaporation (SPE)

Short path evaporation (SPE) or short path distillation is a distillation technique or thermal separation technique operating at reduced pressures. It involves that the distillate is travelling a short distance, often only a few centimetres, at reduced pressure. A short path ensures that almost no compound is lost on the sides of the apparatus.

The short path evaporation is performed to significantly reduce, remove, and mitigate the content of unwanted propanol components such as free chloropronanol, chloropropanol fatty acid esters, free epoxypropanols, epoxypropanol fatty acid esters, and combinations thereof. As it can be seen, the obtained palm oil and/or palm oil based material is having a content of free chloropronanol chloropropanol fatty acid esters of less than 0.8 ppm, less than 0.7 ppm, less than 0.6 ppm, less than 0.5 ppm. In one aspect of the invention, the content of free epoxypropanols, epoxypropanol fatty acid esters, and combinations thereof is less than 0.2 ppm, less than 0.15 ppm, or below LOQ (limit of quantification, of 0.1 ppm)).

The short-path evaporation (SPE) is performed at a temperature of from 90 to 350° C., from 100 to 300° C., preferably from 140° C. to 280° C., 220° C. to 260° C., more preferably from 240-280° C.

Furthermore, the short path evaporation is performed at a pressure below 1 mbar, preferably below 0.05 mbar, more preferably below 0.01 mbar, most preferably below 0.001 mbar.

However, it has been noted that there is a good reason to perform the SPE treatment on the palm or palm oil fractions and bring the other mentioned lipid based material in the fat composition as such. Without being bound to any limitation, it can be understood that beyond the fact that SPE treatment on the palm or palm oil fractions allows obtaining “at least one palm oil and/or palm oil based material” with a content of di-acylglycerides less than 3% and a content of unwanted propanol components of less than 0.8 ppm, there are further advantages in that the at least one lipid-based material is not treated by short path evaporation. There is a potential risk in that during a short path evaporation these “at least one lipid-based materials” would be distilled over, or would be too oxidative sensitive or to oxidative unstable to the SPE treatment and/or they are too expensive (e.g. the yield would be too low) to risk to loose material via the distillate during the SPE treatment. Therefore, the “at least one lipid-based materials” are not treated by short path evaporation. Due to this particular selection of fats, oils and treatments, the fat or oil composition of the present invention can remain unchanged in fatty acid profile and/or have a good oxidation stability and/or they are obtained in good yields.

The current invention demonstrates that the current fat composition fulfils the needs of a reduced content of unwanted propanol components while maintaining the desired fatty acid profile. Likewise the content of di-acylglycerides is significantly reduced and the desired fatty acid profile of the triglycerides remains unchanged.

Unless specified otherwise, the content of the unwanted propanol components such as free chloropropanols, chloropropanol fatty acid esters, free epoxypropanols, epoxypropanol fatty acid esters, and combinations thereof either alone or in combination will be determined using Method DGF Standard Methods Section C (Fats) C-VI 18(10)

The total content of these unwanted propanol components is reduced by at least 30%, most preferably it is reduced by at least 50%, said reduction corresponding to the decrease in the amount of unwanted propanol components of the SPE-treated oil compared with the amount in the corresponding oil before the SPE treatment.

In one aspect of the invention, the “at least one lipid-based material” is containing the unwanted propanol components such as free chloropropanols, chloropropanol fatty acid esters, free epoxypropanols, epoxypropanol fatty acid esters, and combinations thereof in an amount (wt %) of less than 1 ppm, preferably less than 0.75 ppm, more preferably less than 0.50 ppm, less than 0.35 ppm, even more preferably less than 0.25 ppm.

The “at least one lipid-based material” is selected from the group consisting of
a) lauric fat,
b) medium chain triglycerides,
c) fat source containing long chain poly-unsaturated fatty acids,
d) milk fat,
e) liquid oil selected from the group consisting of oils from cotton, corn, groundnut, linseed, olive, rape, canola, rice bran, sesame, safflower, soybean, sunflower, high-oleic safflower, high-oleic sunflower, and combinations of two or more thereof,
f) a triglyceride composition comprising from 40 to 50% by weight of saturated fatty acid residues having 16 carbon atoms and from 40 to 50% by weight of unsaturated fatty acid residues having 18 carbon atoms and one double bond, and wherein from 50 to 60% by weight of the saturated fatty acid residues having 16 carbon atoms are present at the 2-position in a triglyceride, and
g) mixtures of two or more thereof.

The lauric fat in the composition of the present invention is selected from coconut oil, palm kernel oil, babassu oil, cohune oil, tacum oil, cuphea oil, and mixtures of two or more thereof.

The medium chain triglycerides contain at least 80%, preferably at least 90% by weight of fatty acids with a carbon chain length of C6 to C12. In particular these types of triglycerides would be prone to being distilled over in an short path evaporation and would thus result in a modified fatty acid profile. By making sure that only the palm oil and/or palm oil based material is treated by short path evaporation, the fatty acid profile of the lauric fat remains unchanged.

According to the present invention, the mentioned long-chain polyunsaturated fatty acids (LC-PUFAs) are fatty acids with 20 carbons or more, which can be categorized into two main families, i.e. ω6 (n−6) and ω3 (n−3), depending on the position of the first double bond from the methyl end group of the fatty acid.

The fat source containing these long chain poly-unsaturated fatty acids (LC-PUFAs) in the composition of the present invention, relates to fat sources containing arachidonic acid (ARA), eicosapentaenoic acid (EPA) and docosahexaenoic acid (DHA), preferably eicosapentaenoic acid (EPA) and/or docosahexaenoic acid (DHA). Typical examples of suitable fat sources are fish oil, algae oil, fungal oil, and bacterial oil. In one aspect of the present invention, the composition comprises at least 0.30 wt %, at least 0.50 wt %, at least 0.60 wt %, at least 0.70 wt % and at least 1.15 wt % LC-PUFAs with 20 and 22 carbon atoms of the total fat content. In particular these types of lipid materials are too sensitive to be treated by a short path evaporator. By making sure that only the palm oil and/or palm oil based material is treated by short path evaporation, the fatty acid profile of the long-chain polyunsaturated fatty acids (LC-PUFAs) remains unchanged, and/or have a good oxidation stability. These types of lipid-based materials are too expensive to risk to loose material via the distillate during the SPE treatment.

The milk fat is derived from mammalian milk, e;g. bovine milk, goats milk or horses milk. By the term “derived from” it is meant that the milk fat is not separated from the other components of the mammalian milk (apart from water). This may have the advantage that a much better tasting infant formula is produced. The milk fat is likewise not treated by short-path evaporation.

The liquid oil in the composition of the present invention is selected from the group consisting of oils from cotton, corn, groundnut, linseed, olive, rape, canola, rice bran, sesame, safflower, soybean, sunflower, high-oleic safflower, high-oleic sunflower, and mixture of two or more thereof. In particular, these types of lipid-based materials are becoming oxidative instable with increasing unsaturation in the fatty acid profile. Therefore these oils are not treated by short path evaporation.

Furthermore, the “at least one lipid-based material may be a triglyceride composition comprising from 40 to 50% by weight of saturated fatty acid residues having 16 carbon atoms and from 40 to 50% by weight of unsaturated fatty acid residues having 18 carbon atoms and one double bond, and wherein from 50 to 60% by weight of the saturated fatty acid residues having 16 carbon atoms are present at the 2-position in a triglyceride. A typical example of this type of triglyceride is known as 1,3-dioleoyl-2-palmitoyl glyceride (OPO). These types of lipid-based materials are too expensive to risk to loose material via the distillate during the SPE treatment.

The current invention is encompassing the multiple permutations of each and every specified “at least one lipid-based material” in combination with the general or specific description of the other “at least one lipid-based materials”.

The fat or oil composition of the present invention is comprising from 10 to 90 (wt %) of palm oil and/or palm oil based material having a content of di-acylglycerides less than 3% and a content of unwanted propanol components of less than 0.8 ppm.

Furthermore, in another aspect of the invention the fat or oil composition of the present invention is comprising an anti-oxidant.

Suitable antioxidants can be selected from the group consisting of butylated hydroxyanisole (BHA), butylated hydroxytoluene (BHT), propyl gallate (PG), tertiary-butylhydroquinone (TBHQ), citric acid, malic acid, succinic acid, tartaric acid, ascorbic acid, ascorbyl palmitate, erythorbic acid, carotenoids such as β-carotene, lycopene and lutein, synthetic tocopherols, plant extracts such as rosemary extract, green tea extract, carotenoids obtained from a natural source, lecithin, tocopherols, tocotrienols, phytosterols, phytostanols, olive oil phenolic compounds, phenolic compounds of sesam oil such, as sesamin, sesamol, sesamolin, sesaminol, sesamolinol, and the like. It has to be understood that for any of the aforementioned antioxidants and where it is applicable and would make sense, also their corresponding derivatives, including salts, esters, anhydrides and the like, are likewise to be considered as suitable antioxidants. In the field of infant formulae nutritional regulations (dependent upon country and/or region) may suggest a preference for or even ban the use of either one or more of the previously mentioned antioxidants. Preferably citric acid, citric acid esters, ascorbyl palmitate, lecithin, tocopherols and mixtures of two or more thereof are used in infant formulae.

The fat or oil composition of the present invention is containing less than 1 ppm, preferably less than 0.75 ppm, preferably less than 0.50 ppm, preferably less than 0.35 ppm or even more preferably less than 0.25 ppm of unwanted propanol components selected from the group of chloropropanols, chloropropanol fatty acid esters, epoxypropanols, epoxypropanol fatty acid esters, and combinations of two or more thereof. Furthermore, the fatty acid profile of the fat or oil composition of the present invention has not changed.

The present invention further relates to an infant food product comprising infant food ingredients and at least one palm oil and/or palm oil based material, and at least one lipid-based material selected from the group consisting of:
a) lauric fat,
b) medium chain triglycerides,
c) fat source containing long chain poly-unsaturated fatty acids,
d) milk fat,
e) liquid oil selected from the group consisting of oils from cotton, corn, groundnut, linseed, olive, rape, canola, rice bran, sesame, safflower, soybean, sunflower, high-oleic safflower, high-oleic sunflower, and combinations of two or more thereof,
f) a triglyceride composition comprising from 40 to 50% by weight of saturated fatty acid residues having 16 carbon atoms and from 40 to 50% by weight of unsaturated fatty acid residues having 18 carbon atoms and one double bond, and wherein from 50 to 60% by weight of the saturated fatty acid residues having 16 carbon atoms are present at the 2-position in a triglyceride, and
g) mixtures of two or more thereof,
and wherein and the palm oil and/or palm oil based material is having a content of di-acylglycerides less than 3% and a content of unwanted propanol components of less than 0.8 ppm.

The infant food product of the present invention has a suitable or balanced fat composition by adding to the palm oil and/or palm oil based material having a content of di-acylglycerides less than 3% and a content of unwanted propanol components of less than 0.8 ppm, the at least one lipid-based material which is selected from the group consisting of:
a) lauric fat,
b) medium chain triglycerides,
c) fat source containing long chain poly-unsaturated fatty acids,
d) milk fat,
e) liquid oil selected from the group consisting of oils from cotton, corn, groundnut, linseed, olive, rape, canola, rice bran, sesame, safflower, soybean, sunflower, high-oleic safflower, high-oleic sunflower, and combinations of two or more thereof,
f) a triglyceride composition comprising from 40 to 50% by weight of saturated fatty acid residues having 16 carbon atoms and from 40 to 50% by weight of unsaturated fatty acid residues having 18 carbon atoms and one double bond, and wherein from 50 to 60% by weight of the saturated fatty acid residues having 16 carbon atoms are present at the 2-position in a triglyceride, and
g) mixtures of two or more thereof.

The infant food product of the present invention is encompassing the three forms available on the market, i.e. powder, infant base powder, liquid concentrate, and ready-to-feed liquids.

Infant food product is a term well-known in the art and it refers to food that is specifically manufactured for infants and it may be characterized in that is soft, and easily consumable by infants and has a nutritional composition adapted to the specific needs at each growth stage.

Preferably, the infant formula further comprises one or more infant food ingredients. The one or more infant food ingredients are typically selected from the group consisting of proteins, such as (vegetable proteins, whey protein, casein, total milk protein) or protein hydrolysates, carbohydrates (preferably including prebiotic oligosaccharides), minerals, vitamins and mixtures thereof.

The protein component may comprise whole proteins and/or a protein hydrolysate, or a mixture thereof, and is most preferably low in phosphorus, e.g. a phosphorus content of less than 0.75 g/100g protein. Also, when whole proteins are present, they are most preferably such that they are easily digested by the infant.

The prebiotic oligosaccharides include, but are not limited to, lacto-N-tetraose, lacto-N-fucopentaose, lactulose, lactosucrose, raffinose, galacto-oligosaccharides, fructo-oligosaccharides, oligosaccharides derived from soybean polysaccharides, mannose-based oligosaccharides, arabino-oligosaccharides, xylo-oligosaccharides, isomalto-oligosaccharides, glucans, sialyl oligosaccharides, fuco-oligosaccharides, and/or any suitable combination thereof.

The vitamins may include but are not limited to vitamin K, vitamin B1, vitamin B2, vitamin A, vitamin E, vitamin D, vitamin C, niacin, pantothenic acid. Also, besides the usual amounts of these or other vitamins, the infant food product of the invention may contain additional amounts of-for instance-folic acid, vitamin B12 and/or vitamin B6; one or more minerals and/or trace elements; one or more preservatives; one or more flavours and/or colourings.

It relates further to the infant food product according to present invention wherein the infant food product is comprising an antioxidant.

Suitable antioxidants applicable in infant food product can be selected from the aforementioned group. It has to be understood that for any of the aforementioned antioxidants and where it is applicable and would make sense, also their corresponding derivatives, including salts, esters, anhydrides and the like, are likewise to be considered as suitable antioxidants.

The infant food product of the present invention preferably has one or more advantages over conventional infant formulae such as appropriate flavour properties and/or dispersion properties and/or whiteness of colour, nutritional value and low in content of unwanted propanol components.

Furthermore, the present invention relates to the use of palm oil and/or palm oil based material having a content of di-acylglycerides less than 3% and a content of unwanted propanol components of less than 0.8 ppm with at least one lipid-based material selected from the group consisting of
a) lauric fat,
b) medium chain triglycerides,
c) fat source containing long chain poly-unsaturated fatty acids,
d) milk fat,
e) liquid oil selected from the group consisting of oils from cotton, corn, groundnut, linseed, olive, rape, canola, rice bran, sesame, safflower, soybean, sunflower, high-oleic safflower, high-oleic sunflower, and combinations of two or more thereof,
f) a triglyceride composition comprising from 40 to 50% by weight of saturated fatty acid residues having 16 carbon atoms and from 40 to 50% by weight of unsaturated fatty acid residues having 18 carbon atoms and one double bond, and wherein from 50 to 60% by weight of the saturated fatty acid residues having 16 carbon atoms are present at the 2-position in a triglyceride, and
g) mixtures of two or more thereof,
to prepare an infant food product.

It further relates to the use of the fat composition of the present invention to reduce the content of unwanted propanol components selected from the group consisting of chloropronanols, chloropropanol fatty acid esters, epoxypropanols, epoxypropanol fatty acid esters, and combinations of two or more thereof in infant food product.

1. A fat or oil composition comprising at least one palm oil or palm oil based material and at least one lipid-based material selected from the group consisting of
a) lauric fat,
b) medium chain triglycerides,
c) fat source containing long chain poly-unsaturated fatty acids,
d) milk fat,
e) liquid oil selected from the group consisting of oils from cotton, corn, groundnut, linseed, olive, rape, canola, rice bran, sesame, safflower, soybean, sunflower, high-oleic safflower, high-oleic sunflower, and combinations of two or more thereof,
f) a triglyceride composition comprising from 40 to 50% by weight of saturated fatty acid residues having 16 carbon atoms and from 40 to 50% by weight of unsaturated fatty acid residues having 18 carbon atoms and one double bond, and wherein from 50 to 60% by weight of the saturated fatty acid residues having 16 carbon atoms are present at the 2-position in a triglyceride, and
g) mixtures of two or more thereof,
and wherein the palm oil or palm oil based material has a content of di-acylglycerides less than 3% and a content of unwanted propanol components of less than 0.8 ppm.

2. The fat or oil composition according to claim 1 wherein the lauric fat is selected from coconut oil, palm kernel oil, babassu oil, cohune oil, tacum oil, cuphea oil, and mixtures of two or more thereof.

3. The fat or oil composition according to claim 1 wherein the fat or oil composition is comprising from 10 to 90 (wt %) of short-path evaporated palm oil or short-path evaporated palm oil based material.

4. The fat or oil composition according to claim 1 wherein the fat or oil composition comprises an anti-oxidant.

5. The fat or oil composition according to claim 1 wherein the composition is containing less than 1 ppm of unwanted propanol components selected from the group of chloropropanols, chloropropanol fatty acid esters, epoxypropanols, epoxypropanol fatty acid esters, and combinations of two or more thereof.

6. An infant food product comprising infant food ingredients and at least one palm oil or palm oil based material and at least one lipid-based material selected from the group consisting of:
a) lauric fat,
b) medium chain triglycerides,
c) fat source containing long chain poly-unsaturated fatty acids,
d) milk fat,
e) liquid oil selected from the group consisting of oils from cotton, corn, groundnut, linseed, olive, rape, canola, rice bran, sesame, safflower, soybean, sunflower, high-oleic safflower, high-oleic sunflower, and combinations of two or more thereof,
f) a triglyceride composition comprising from 40 to 50% by weight of saturated fatty acid residues having 16 carbon atoms and from 40 to 50% by weight of unsaturated fatty acid residues having 18 carbon atoms and one double bond, and wherein from 50 to 60% by weight of the saturated fatty acid residues having 16 carbon atoms are present at the 2-position in a triglyceride, and
g) mixtures of two or more thereof,
and wherein the palm oil or palm oil based material has a content of di-acylglycerides less than 3% and a content of unwanted propanol components of less than 0.8 ppm.

7. The infant food product according to claim 6 wherein the infant food product comprises an antioxidant.

8. (canceled)

9. (canceled)
